(19) United States
(12) Patent Application Publication
(10) Pub. No.: US 2017/0300202 A1
(43) Pub. Date: Oct. 19, 2017

(54) IMAGE DISPLAY DEVICE, TELEVISION RECEIVER, AND IMAGE DISPLAY METHOD

(71) Applicant: Sharp Kabushiki Kaisha, Osaka (JP)

(72) Inventors: GOH NAKAGAWA, Osaka (JP); YUHJI TAKEBAYASHI, Osaka (JP); HIROYASU OHGI, Osaka (JP); MIYUKI WATANABE, Osaka (JP); HIROKI ABE, Osaka (JP); YUJI KAMON, Osaka (JP)

(73) Assignee: Sharp Kabushiki Kaisha, Osaka (JP)

(21) Appl. No.: 15/512,573

(22) PCT Filed: Oct. 23, 2015
(86) PCT No.: PCT/JP2015/080004

§ 371 Date: Mar. 20, 2017

(30) Foreign Application Priority Data
Nov. 7, 2014 (JP) JP2014-227454

(51) Int. Cl. G06F 3/0483; G06F 3/0481; G06F 3/0485; G06F 3/0482; H04N 5/44

(52) U.S. Cl. CPC G06F 3/0483; G06F 3/0485; G06F 3/0482; G06F 3/04817; H04N 5/4403; H04N 2005/4412

(57) ABSTRACT

There is provided a technique for easily determining a position of a page that is displayed in an electronic document. A television receiver (1) includes a table-of-contents image generating unit (112) that generates a table-of-contents image which represents a table of contents of an electronic document and which is to be displayed on a display, the table of contents having two or more layers; and a text image generating unit (113) that generates a text image which represents a text of the electronic document and which is to be displayed on the display. The table-of-contents image generating unit changes an upper-level item that is opened in a generated table-of-contents image to a changed upper-level item, in response to a change of an upper-level item including an item corresponding to the text image generated by the text image generating unit.

### TECHNICAL FIELD

The present invention relates to an image display device that displays an image representing an electronic document on a display, a television receiver, and an image display method.

### BACKGROUND ART

Hitherto, electronic documents such as electronic instruction manuals of electric equipment have become widely available. Among image display devices that display an image representing such an electronic document on a display, there is an image display device that simultaneously displays a table of contents and text (page) included in an electronic document in different areas, and also there is an image display device that displays items constituting a table of contents in a hierarchical manner.

For example, PTL 1 discloses a document processing device that displays a headline corresponding to a cursor position in a text area in a table-of-contents area and that displays a document corresponding to a cursor position in the table-of-contents area in the text area. PTL 2 discloses an electronic manual display device that is capable of, with a user operation, opening/closing items constituting a table of contents. Here, opening an item means making a lower-level item of the item visible, whereas closing an item means making a lower-level item of the item invisible. PTL 3 discloses an electronic document converting device that creates a summary of a table of contents in accordance with a rule based on an attribute of a display device and that enables the table of contents to be displayed on a display with a small display area.

### CITATION LIST

### Patent Literature

PTL 1: Japanese Unexamined Patent Application Publication No. 8-147301 (published on Jun. 7, 1996)

PTL 2: Japanese Unexamined Patent Application Publication No. 2006-277397 (published on Oct. 12, 2006)

PTL 3: Japanese Unexamined Patent Application Publication No. 2012-141702 (published on Jul. 26, 2012)

### SUMMARY OF INVENTION

### Technical Problem

However, the related art described above has a problem that, in a case where a page that is displayed corresponds to a lower-level item of a closed item, the lower-level item is invisible and thus it is difficult for a user to determine which part of an electronic document corresponds to the page that is displayed. Furthermore, the related art has a problem that it is impossible to locate a cursor on the lower-level item.

The present invention has been made in view of the foregoing problems, and an object thereof is to provide a technique for easily determining the position of a page that is displayed in an electronic document.

### Solution to Problem

To solve the foregoing problems, an image display device according to an aspect of the present invention is an image display device that displays an image representing an electronic document on a display, including: a table-of-contents image generating unit that generates a table-of-contents image which represents a table of contents of the electronic document and which is to be displayed on the display, the table of contents having two or more layers; and a page image generating unit that generates a page image which represents a page of the electronic document and which is to be displayed on the display, wherein the table-of-contents image generating unit changes an upper-level item that is opened in a generated table-of-contents image from a first upper-level item to a second upper-level item, in response to a change of an upper-level item including an item corresponding to the page image generated by the page image generating unit from the first upper-level item to the second upper-level item.

A television receiver according to an aspect of the present invention includes the foregoing image display device.

An image display method according to an aspect of the present invention is an image display method for displaying an image representing an electronic document on a display, including: a table-of-contents image generation step of generating a table-of-contents image which represents a table of contents of the electronic document and which is to be displayed on the display, the table of contents having two or more layers; and a page image generation step of generating a page image which represents a page of the electronic document and which is to be displayed on the display, wherein the table-of-contents image generation step changes an upper-level item that is opened in a generated table-of-contents image from a first upper-level item to a second upper-level item, in response to a change of an upper-level item including an item corresponding to the page image generated in the page image generation step from the first upper-level item to the second upper-level item.

### Advantageous Effects of Invention

According to an aspect of the present invention, an advantage is provided in which the position of a page that is displayed in an electronic document can be easily determined.

### BRIEF DESCRIPTION OF DRAWINGS

FIG. 1 is a block diagram illustrating the configuration of a television receiver according to a first embodiment of the present invention.

FIG. 2 is a diagram illustrating an example configuration of electronic-document data according to the first embodiment of the present invention.

FIG. 3 is a diagram illustrating a display example of an electronic-document image according to the first embodiment of the present invention.

FIG. 4 is a diagram illustrating a display example of a table-of-contents image that is displayed in conjunction with a page forward operation of a text image according to the first embodiment of the present invention.

FIG. 5 is a diagram illustrating an example of movement of a cursor from a text image to a table-of-contents image according to the first embodiment of the present invention.

FIG. 6 is a diagram illustrating a display example of an electronic-document image that is displayed in conjunction with an operation of a table-of-contents image according to the first embodiment of the present invention.

FIG. 7 is a diagram illustrating examples of a video output device according to the first embodiment of the present invention, in which (a) illustrates an example of a television receiver, (b) illustrates an example of a video recorder, and (c) illustrates an example of an STB.

FIG. 8 is a diagram illustrating an example of the arrangement of keys on a remote control according to the first embodiment of the present invention.

FIG. 9 is a diagram illustrating a display example of an electronic-document image at the time of movement to a link and return from the link according to a second embodiment of the present invention.

FIG. 10 is a diagram illustrating an example of automatic scrolling of a table-of-contents image according to a third embodiment of the present invention, in which (a) illustrates an example of automatic scrolling of a table-of-contents image in conjunction with paging of a text image and (b) illustrates an example of automatic scrolling of a table-of-contents image in conjunction with movement to a link.

FIG. 11 is a diagram illustrating a display example of a page forward operation and a page back operation using color keys in a text image according to a fourth embodiment of the present invention.

FIG. 12 is a diagram illustrating a display example of a page forward operation and a page back operation using color keys in a table-of-contents image according to the fourth embodiment of the present invention.

### DESCRIPTION OF EMBODIMENTS

### First Embodiment

Hereinafter, embodiments of the present invention will be described in detail. Note that the configurations described in the embodiments are merely examples, and the scope of the present invention is not limited thereto unless otherwise specified.

### <Configuration and Overview of Television Receiver>

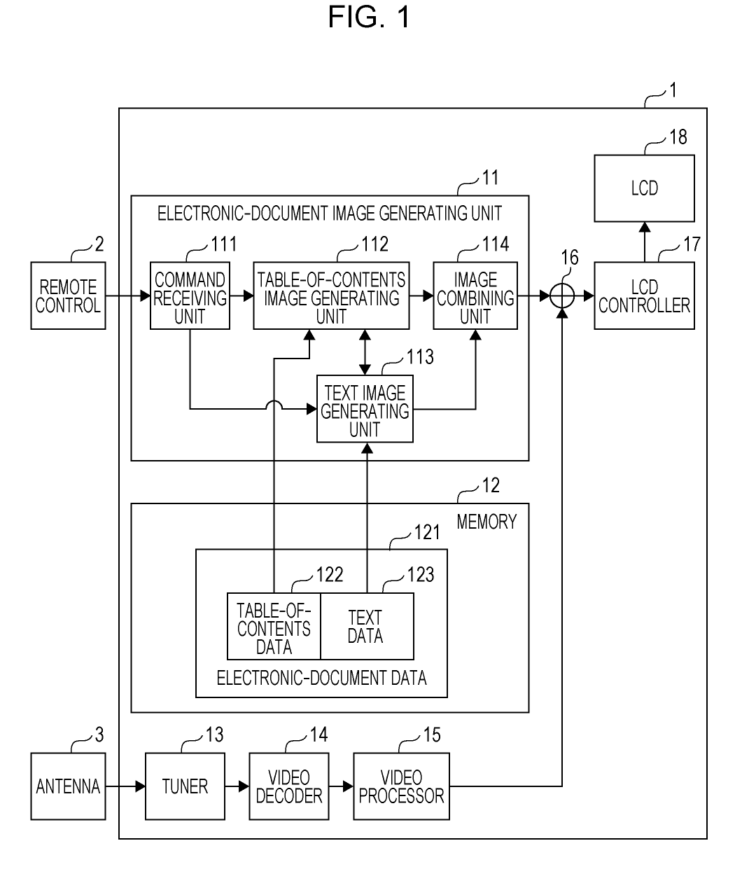

First, a television receiver (hereinafter abbreviated as “television”) according to a first embodiment of the present invention will be described with reference to FIG. 1. FIG. 1 is a block diagram illustrating the configuration of a television 1 according to the first embodiment of the present invention. As illustrated in FIG. 1, the television 1 has a function of displaying an electronic document in response to an operation through a remote control 2, in addition to a function of receiving video from an antenna 3 and displaying the video, and includes an electronic-document image generating unit 11, a memory 12, a tuner 13, a video decoder 14, a video processor 15, a superimposing unit 16, an LCD controller 17, and an LCD (display) 18.

The electronic-document image generating unit 11 receives a command from the remote control 2 and generates an image representing an electronic document in accordance with the command, and includes a command receiving unit Ill, a table-of-contents image generating unit 112, a text image generating unit (page image generating unit) 113, and an image combining unit 114. The command receiving unit 111 receives a command corresponding to a user operation from the remote control 2 and provides an instruction corresponding to the command to the table-of-contents image generating unit 112 and the text image generating unit 113. In response to the instruction from the command receiving unit 111, the table-of-contents image generating unit 112 reads table-of-contents data 122 from the memory 12 and performs a predetermined process, and thereby generates a table-of-contents image representing a table of contents of an electronic document and outputs the table-of-contents image to the image combining unit 114. In response to the instruction from the command receiving unit 111, the text image generating unit 113 reads text data 123 from the memory 12 and performs a predetermined process, and thereby generates a text image (page image) representing (a page of) the text of the electronic document and outputs the text image to the image combining unit 114. The table-of-contents image generating unit 112 and the text image generating unit 113 transmit/receive control information to/from each other as necessary. The image combining unit 114 obtains the table-of-contents image from the table-of-contents image generating unit 112, obtains the text image from the text image generating unit 113, combines the table-of-contents image and the text image to generate an electronic-document image, and outputs electronic-document image data to the superimposing unit 16.

The memory 12 stores electronic-document data 121. The electronic-document data 121 is, for example, data of an electronic instruction manual of the television 1, and is formed of the table-of-contents data 122 and the text data 123. The table-of-contents data 122 is data of a table of contents of an electronic document and has a hierarchical structure. The text data 123 is data of text of an electronic document and is formed of one or more pages. The table-of-contents data 122 and the text data 123 are associated with each other. The details of the electronic-document data 121 will be described below.

The tuner 13 obtains a video signal of a predetermined channel from the antenna 3 and outputs the video signal to the video decoder 14. The video decoder 14 obtains the video signal from the tuner 13, decodes the video signal, and outputs video data to the video processor 15. The video processor 15 obtains the video data from the video decoder 14, performs image processing on the basis of image quality information, and thereby adjusts the image quality of the obtained video data and outputs the video data to the superimposing unit 16.

The superimposing unit 16 obtains the electronic-document image data from the electronic-document image generating unit 11, obtains the video data from the video processor 15, superimposes the electronic-document image data and the video data one on top of another, and outputs display image data obtained through the superimposition to the LCD controller 17. The LCD controller 17 obtains the display image data from the superimposing unit 16 and controls the LCD 18 to display the display image data.

### <Configuration of Data>

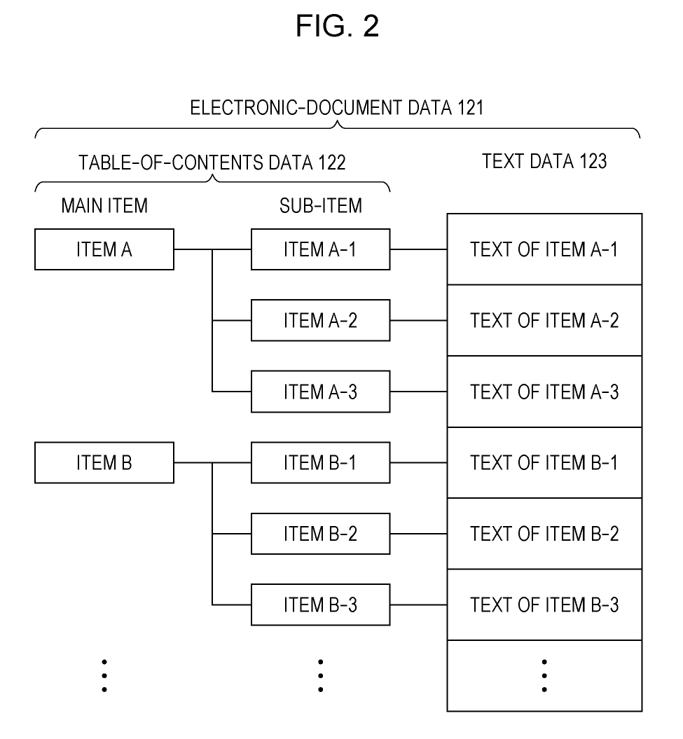

Next, the configuration of electronic-document data according to the first embodiment of the present invention will be described with reference to FIG. 2. FIG. 2 is a diagram illustrating an example configuration of the electronic-document data 121 according to the first embodiment of the present invention. As illustrated in FIG. 2, the electronic-document data 121 is formed of the table-of-contents data 122 and the text data 123. The table-of-contents data 122 has a hierarchical structure including main items (upper-level items) and sub-items (items). A main item in an upper layer and one or more sub-items in a lower layer are associated with each other. For example, item A is associated with item A-1, item A-2, and item A-3. Also, item B is associated with item B-1, item B-2, and item B-3. With use of such associations, display/non-display of sub-items in a table-of-contents image is controlled.

Furthermore, individual sub-items, which are in the lowest layer of the table-of-contents data 122, and individual texts (formed of one or plural pages) of the text data 123 are associated with each other in a one-to-one relationship. For example, item A-1 is associated with the text of item A-1, item A-2 is associated with the text of item A-2, and item A-3 is associated with the text of item A-3. Also, item B-1 is associated with the text of item B-1, item B-2 is associated with the text of item B-2, and item B-3 is associated with the text of item B-3. With use of such associations, open display and identification display of a table of contents corresponding to a text image in a table-of-contents image are performed.

### <Display of Electronic-Document Image>

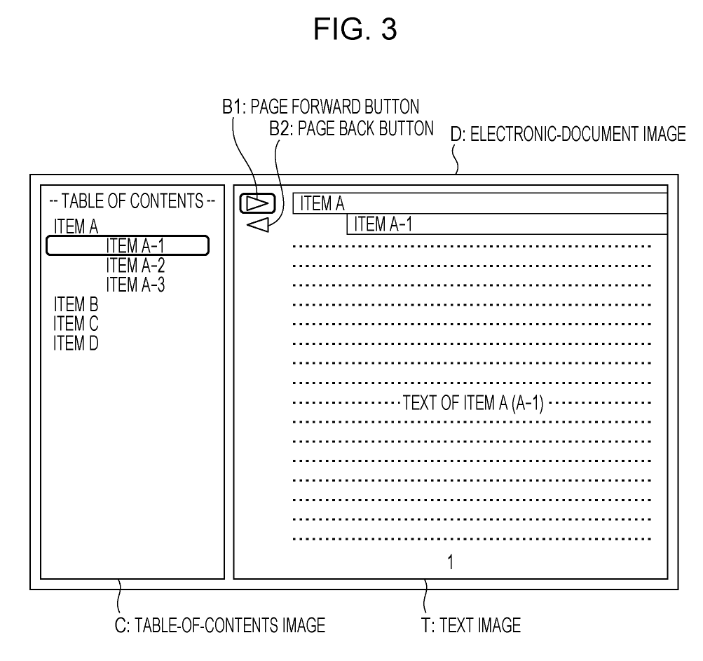

Next, an example of an electronic-document image displayed on the LCD according to the first embodiment of the present invention will be described with reference to FIG. 3. FIG. 3 is a diagram illustrating a display example of an electronic-document image D according to the first embodiment of the present invention. As illustrated in FIG. 3, the electronic-document image D is formed of a table-of-contents image C and a text image T. The electronic-document image D is displayed on the screen of the LCD 18 when an instruction manual key on the remote control 2 is pressed.

In the table-of-contents image C, a text indicating that the image is a table of contents (in the example illustrated in the figure, “˜˜TABLE OF CONTENTS˜˜”) is depicted, and main items and sub-items are depicted hierarchically. In the text image T, a text indicating that the image is the text of item A and item A-1 (in the example illustrated in the figure, “ITEM A” and “ITEM A-1”) is depicted, the text thereof is depicted, and also a page forward button B1 and a page back button B2 (page switch button) are depicted. Also, in the example illustrated in the figure, a cursor indicating a target to be operated is located on the page forward button B. Furthermore, in the example illustrated in the figure, in the table-of-contents image C, item A is opened and item A-1, item A-2, and item A-3 in the lower layer of item A are depicted. In addition, item A-1 corresponding to the text displayed as the text image T is highlighted. Accordingly, item A-1 corresponding to the text is distinguishable from the other items A-2 and A-3.

The foregoing electronic-document image D is generated, for example, under the following control. That is, if the instruction manual key on the remote control 2 is pressed, referring to FIG. 1, the command receiving unit III receives a command to display an electronic instruction manual from the remote control 2, instructs the table-of-contents image generating unit 112 to generate the table-of-contents image C including highlight display of an item including one page of the electronic instruction manual, and instructs the text image generating unit 113 to generate the text image T of the one page. In response to the instruction from the command receiving unit Ill, the table-of-contents image generating unit 112 reads the table-of-contents data 122, generates the table-of-contents image C including highlight display of item A-1, and outputs the table-of-contents image C to the image combining unit 114. In response to the instruction from the command receiving unit 111, the text image generating unit 113 reads the text data 123, generates the text image T of the one page, and outputs the text image T to the image combining unit 114.

In the electronic-document image D illustrated in FIG. 3, if an enter key on the remote control 2 is pressed, referring to FIG. 1, the command receiving unit 111 receives, from the remote control 2, a command to perform a process in accordance with the position where the cursor is located, instructs the table-of-contents image generating unit 112 to generate the table-of-contents image C in accordance with control information from the text image generating unit 113, and instructs the text image generating unit 113 to perform a process in accordance with the position where the cursor is located. In response to the instruction from the command receiving unit 111, the text image generating unit 113 recognizes that the cursor is located on the page forward button B1 in the current text image T, generates the text image T by reading the next page (page 2) from the text data 123, outputs the text image T to the image combining unit 114, and, in a case where the item in the table of contents including the next page is changed from the current item, transmits identification information representing the changed item as control information to the table-of-contents image generating unit 112. In response to receipt of the control information from the text image generating unit 113, the table-of-contents image generating unit 112 generates the table-of-contents image C in which the item represented by the identification information of the control information is highlighted and outputs the table-of-contents image C to the image combining unit 114.

As illustrated in FIG. 3, the page forward button B1 and the page back button B2 are displayed so as to be arranged in the vertical direction, and are not arranged in the horizontal direction, like < >. This is because, if the buttons are arranged in the horizontal direction (the page back button is on the left and the page forward button is on the right) and if a right key is pressed in a state where the cursor is in the table-of-contents image C, it is necessary to move the cursor via the page back button in order to put the cursor on the page forward button in the text image T, and it is necessary to press a left key twice in order to go back from the text image T to the table-of-contents image C by using the left key. Such an operation is unnatural, complicated, and inconvenient.

In contrast, with the buttons being arranged in the vertical direction as in this embodiment, the cursor is first put on the page forward button B1 when the cursor is moved from the table-of-contents image C to the text image T, which is very convenient.

The number of layers of the table-of-contents data 122 and the table-of-contents image C according to this embodiment is not limited to two and may be three or more. For example, in the case of displaying a sub-item corresponding to the text displayed as the text image T in the table-of-contents image C in a case where the table-of-contents image C has three layers of a main item, an intermediate item, and a sub-item, a main item including an intermediate item including the sub-item may be opened so that the intermediate item is displayed, and then the intermediate item may be opened so that the sub-item is displayed. Alternatively, another opening method may be used.

### <Display Example of Table-of-Contents Image and Text Image>

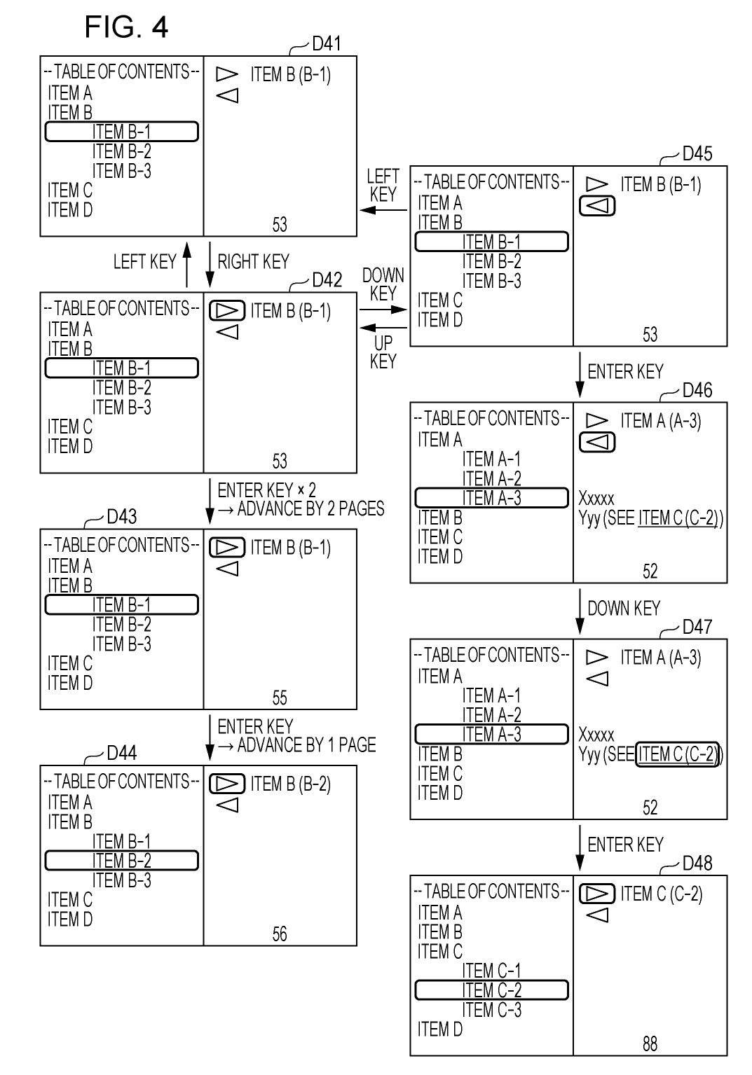

Next, a table-of-contents image that is changed in conjunction with a page forward operation of a text image according to the first embodiment of the present invention will be described with reference to FIG. 4. FIG. 4 is a diagram illustrating a display example of the table-of-contents image C that is displayed in conjunction with a page forward operation of the text image T according to the first embodiment of the present invention. As illustrated in FIG. 4, in the table-of-contents image C, a main item including a sub-item corresponding to a page that is currently displayed as the text image T (hereinafter referred to as a “displayed page”) is opened in conjunction with a page forward operation and a page back operation of the text image T using the remote control 2, and the sub-item is highlighted. Also, a main item that is opened before the operation but does not include a sub-item corresponding to a displayed page any more as a result of the operation is closed. Hereinafter, the details will be described.

First, in an electronic-document image D41 illustrated at the upper left, the cursor is located on item B-1 in the table-of-contents image C, and the text of item B (B-1) is displayed as the text image T. Here, if the right key of the remote control 2 (hereinafter omitted) is pressed, the cursor is located on the page forward button B1 as illustrated in an electronic-document image D42. In this way, the cursor is located on the page forward button B1 when the cursor is moved from the table-of-contents image C to the text image T. Thus, an operation of moving on to the next page can be performed preferentially and quickly, and the remote control 2 can be easily operated. Here, if the left key is pressed, the screen returns to the electronic-document image D41.

If the enter key is pressed twice in the electronic-document image D42, the text image T advances by two pages from page 53 and page 55 is displayed, as illustrated in an electronic-document image D43. However, since pages 53 to 55 are included in the text of the same item B (B-1), the sub-item highlighted in the table-of-contents image C is still item B-1.

Specifically, if the enter key is pressed once in a state where the cursor is located on the page forward button B1, page 54 is displayed and the cursor is located again on the page forward button B1. If the enter key is further pressed once in that state, page 55 is displayed and the cursor is located again on the page forward button B1. According to the above, the cursor is located again on the page forward button B1 when the enter key is pressed with the cursor being on the page forward button B1, and thus consecutive pressing of the page forward button B1 can be easily performed by using the remote control 2.

If the enter key is further pressed in the electronic-document image D43, the text image T advances by one page from page 55 and page 56 is displayed. However, since page 56 is included in the text of item B (B-2), the sub-item highlighted in the table-of-contents image C is changed from item B-1 to item B-2.

Furthermore, if a down key is pressed in the electronic-document image D42, the cursor is located on the page back button B2, as illustrated in an electronic-document image D45. Here, if an up key is pressed, the screen returns to the electronic-document image D42. If the left key is pressed, the screen returns to the electronic-document image D41.

If the enter key is pressed in the electronic-document image D45, page 52 included in the text of item A (A-3) is displayed as the text image T, and in the table-of-contents image C, item B is closed whereas item A is opened and item A-3 is highlighted, as illustrated in an electronic-document image D46.

Specifically, if the enter key is pressed once in a state where the cursor is located on the page back button B2, page 52 is displayed and the cursor is located again on the page forward button B1. According to the above, the cursor is located again on the page back button B2 when the enter key is pressed with the cursor being on the page back button B2, and thus consecutive pressing of the page back button B2 can be easily performed by using the remote control 2.

If the down key is pressed in the electronic-document image D46, the cursor is located on “item C (C-2)”, which is a link displayed on the text in the text image T, as illustrated in an electronic-document image D47. If the enter key is pressed at this time, page 88 of the text of linked item C (C-2) is displayed as the text image T, and in the table-of-contents image C, item A is closed whereas item C is opened and item C-2 is highlighted, as illustrated in an electronic-document image D48.

According to the above, the item corresponding to the text displayed as the text image T is displayed on the table-of-contents image C and furthermore the item is highlighted. Thus, the part in the entire text that is referred to is easily identified. Also, if the enter key is pressed with the cursor being on the page forward button B1, an instruction manual can be read in order from the first page in a manner as if the instruction manual is a printed material.

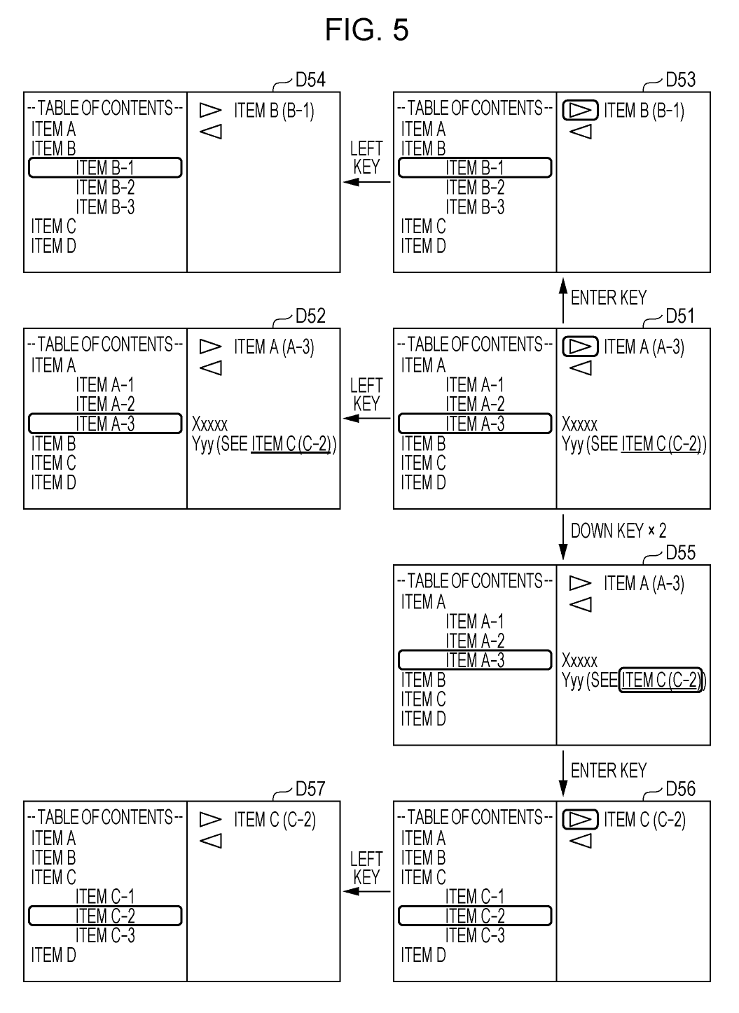

Next, movement of a cursor from a text image to a table-of-contents image according to the first embodiment of the present invention will be described with reference to FIG. 5. FIG. 5 is a diagram illustrating an example of movement of a cursor from the text image T to the table-of-contents image C according to the first embodiment of the present invention. As illustrated in FIG. 5, if an operation of pressing the left key is performed and the cursor moves from the text image T to the table-of-contents image C, the cursor is located on the sub-item corresponding to the text including the displayed page. The sub-item is highlighted before the foregoing operation. With the foregoing operation being performed, the cursor is located on the same sub-item. Hereinafter, the details will be described.

In an electronic-document image D51, which is the second image from the top on the right side, the text of item A (A-3) is displayed as the text image T, the cursor is located on the page forward button B1, and item A-3 which is the sub-item corresponding to the text is highlighted in the table-of-contents image C. Here, if the left key is pressed, the cursor is located on item A-3 which is the sub-item corresponding to the text in the table-of-contents image C, as illustrated in an electronic-document image D52. For example, a yellow frame is displayed as the cursor on the item in addition to highlight display. At this time, the sub-item on which the cursor is to be located is specified by item A-3 or identification information such as an ID identifying it.

If the enter key is pressed in the electronic-document image D51, the text of item B (B-1) is displayed as the text image T, and in the table-of-contents image C, item B-1 which is the sub-item corresponding to the text is highlighted, as illustrated in an electronic-document image D53. Here, if the left key is pressed, the cursor is located on item B-1 which is the sub-item corresponding to the text in the table-of-contents image C, as illustrated in an electronic-document image D54.

If the down key is pressed twice in the electronic-document image D51, the cursor moves from the page forward button B1 via the page back button B2 and is located on a link in the text, as illustrated in an electronic-document image D55. Here, if the enter key is pressed, the text of linked item C (C-2) is displayed as the text image T, and item C-2 which is the sub-item corresponding to the text is highlighted in the table-of-contents image C, as illustrated in an electronic-document image D56.

Here, if the left key is pressed, the cursor is located on item C-2 which is the sub-item corresponding to the text in the table-of-contents image C, as illustrated in an electronic-document image D57.

According to the above, the cursor is located on the sub-item corresponding to the text of the text image T when the cursor is moved from the text image T to the table-of-contents image C. Thus, the sub-item corresponding to the text can be quickly selected without moving the cursor up or down in the table-of-contents image C.

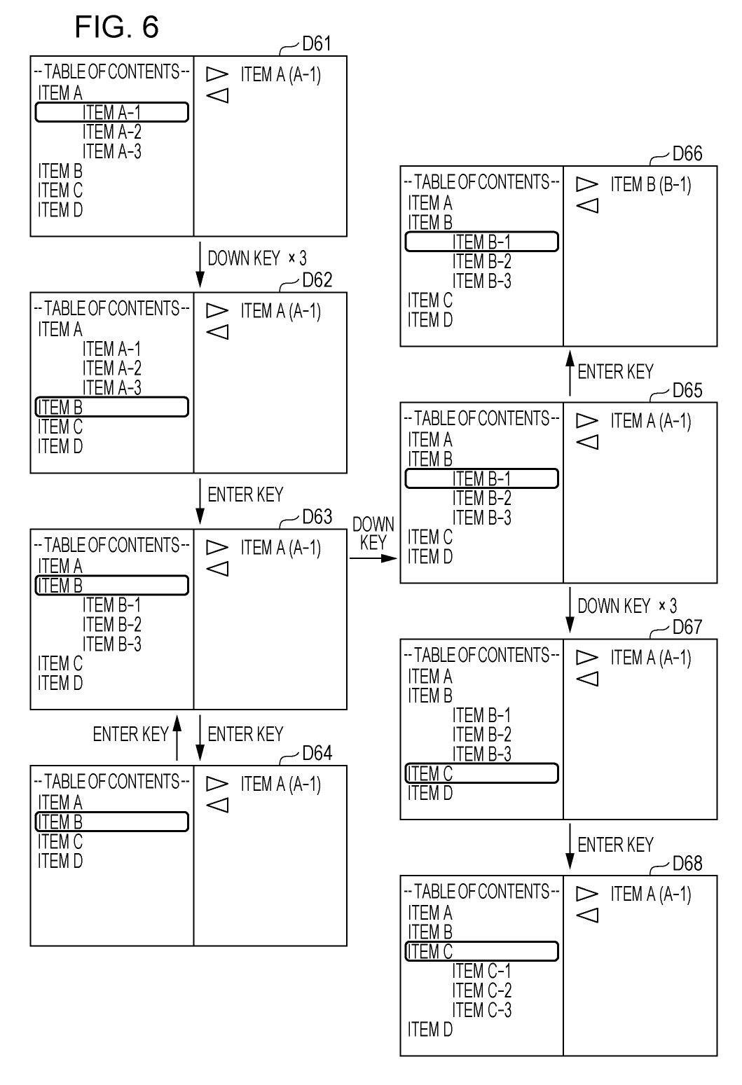

Next, an operation of a table-of-contents image and change in display of the table-of-contents image according to the first embodiment of the present invention will be described with reference to FIG. 6. FIG. 6 is a diagram illustrating a display example of the electronic-document image D that is displayed in conjunction with an operation of the table-of-contents image C according to the first embodiment of the present invention. As illustrated in FIG. 6, in the table-of-contents image C, if the enter key is pressed in a state where the cursor is located on a main item, the main item is opened if the main item is closed, whereas if there is another main item that is opened, the main item is closed. Likewise, if the enter key is pressed when the main item is opened, the main item is closed. Furthermore, if the enter key is pressed in a state where the cursor is located on a sub-item, a page of the text corresponding to the sub-item is displayed as the text image T. Hereinafter, the details will be described.

In an electronic-document image D61 at the upper left, the cursor is located on item A-1 in the table-of-contents image C. Here, if the down key is pressed three times, the cursor is located on item B as illustrated in an electronic-document image D62. Here, if the enter key is pressed, item A is closed and item B is opened as illustrated in an electronic-document image D63. Furthermore, if the enter key is pressed, item B is closed as illustrated in an electronic-document image D64. Here, if the enter key is pressed, the screen returns to the electronic-document image D63 and item B is opened.

If the down key is pressed in the electronic-document image D63, the cursor is located on item B-1 as illustrated in an electronic-document image D65. Here, if the enter key is pressed, the text of item B (B-1) on which the cursor is located in the table-of-contents image C is displayed as the text image T, as illustrated in an electronic-document image D66.

If the down key is pressed three times in the electronic-document image D65, the cursor is located on item C as illustrated in an electronic-document image D67. Here, if the enter key is pressed, item B is closed and item C is opened as illustrated in an electronic-document image D68.

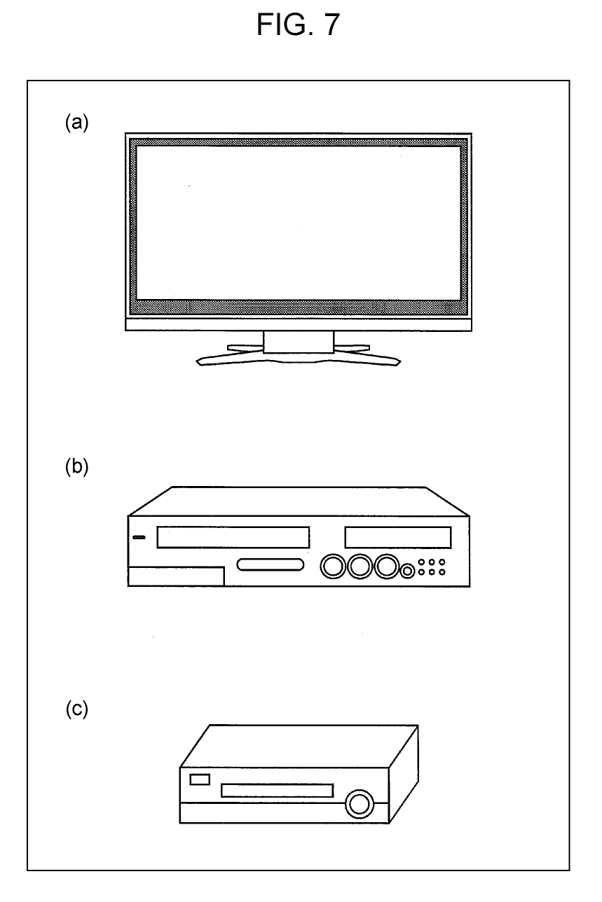

In the above description, this embodiment is applied to a television receiver. However, this embodiment is also applicable to any video output devices as well as the television receiver, for example, to a video recorder or a set top box (STB) of cable television. Also, this embodiment may be applied to an STB of a USB dongle type. FIG. 7 is a diagram illustrating examples of a video output device according to the first embodiment of the present invention. FIG. 7(a) illustrates an example of a television receiver, FIG. 7(b) illustrates an example of a video recorder, and FIG. 7(c) illustrates an example of an STB.

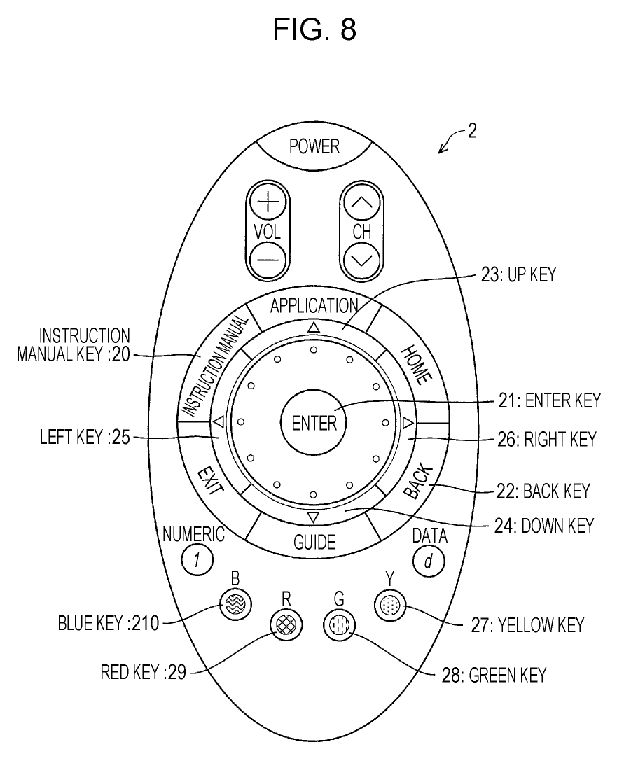

In addition, the arrangement of keys on the remote control according to the first embodiment of the present invention will be described with reference to FIG. 8. FIG. 8 is a diagram illustrating an example of the arrangement of keys on the remote control 2 according to the first embodiment of the present invention. As illustrated in FIG. 8, for example, an instruction manual key 20, an enter key 21, a back key 22, an up key 23, a down key 24, a left key 25, a right key 26, a yellow key 27, a green key 28, a red key 29, and a blue key 210 are arranged on a top surface of the remote control 2. The instruction manual key 20 is operated to display the electronic-document image D on the screen of the LCD 18. The operations of the enter key 21, the up key 23, the down key 24, the left key 25, and the right key 26 have been described above. The operations of the back key 22, the yellow key 27, the green key 28, the red key 29, and the blue key 210 will be described below.

### Second Embodiment

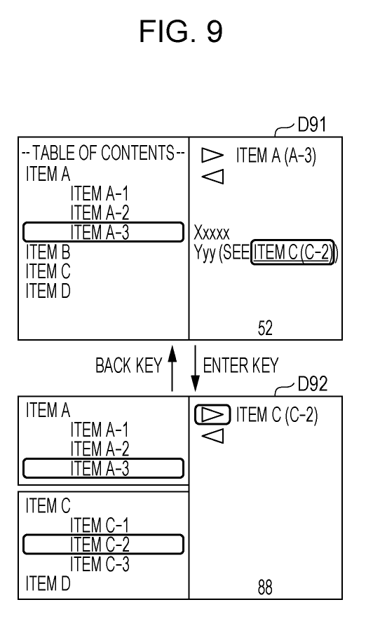

A display example of the electronic-document image D according to a second embodiment of the present invention will be described with reference to FIG. 9. The configurations of the television receiver 1 and the electronic-document image D according to the second embodiment of the present invention are the same as those in the first embodiment.

FIG. 9 is a diagram illustrating a display example of the electronic-document image D at the time of movement to a link and return from the link according to the second embodiment of the present invention. As illustrated in FIG. 9, in an electronic-document image D91, page 52 included in the text of item A (A-3) is displayed as the text image T, a link “item C (C-2)” is displayed in the text, and the cursor is located on “item C (C-2)”. In the table-of-contents image C, item A is opened and item A-3 corresponding to the text is highlighted.

If the enter key is pressed in the electronic-document image D91, the text of linked item C (C-2) is displayed as the text image T, as illustrated in an electronic-document image D92. At the same time, in the table-of-contents image C, item A is opened, item A-3 remains highlighted, item B is deleted and a space is provided at the position, item C is opened, and item C-2 corresponding to the text is highlighted. That is, the table-of-contents image C is displayed so as to be divided into the item (main item and sub-items) corresponding to the text originally displayed as the text image T and the item corresponding to the linked text that is currently displayed. In a case where a linked text is consecutively displayed, the table-of-contents image C may be displayed so as to be divided into three, four, or more portions.

If the back key is pressed in the electronic-document image D92, the screen returns to the electronic-document image D91, where the text of item A (A-3) is displayed, item B is displayed, item C is closed, item A is opened, and item A-3 is highlighted.

According to the above, when the text image T is moved to a link in the text, the item of the text displayed before the movement is highlighted, and thus the portion to return with pressing of the back key can be easily identified. Thus, movement to a linked page can be quickly performed and also return to the previous page can be easily performed.

The second embodiment of the present invention relates to movement to a link displayed in the text image T and to return from the link, and is an alternative to the display example of the electronic-document image D56 in FIG. 5 according to the first embodiment, but is applicable together with other display examples.

### Third Embodiment

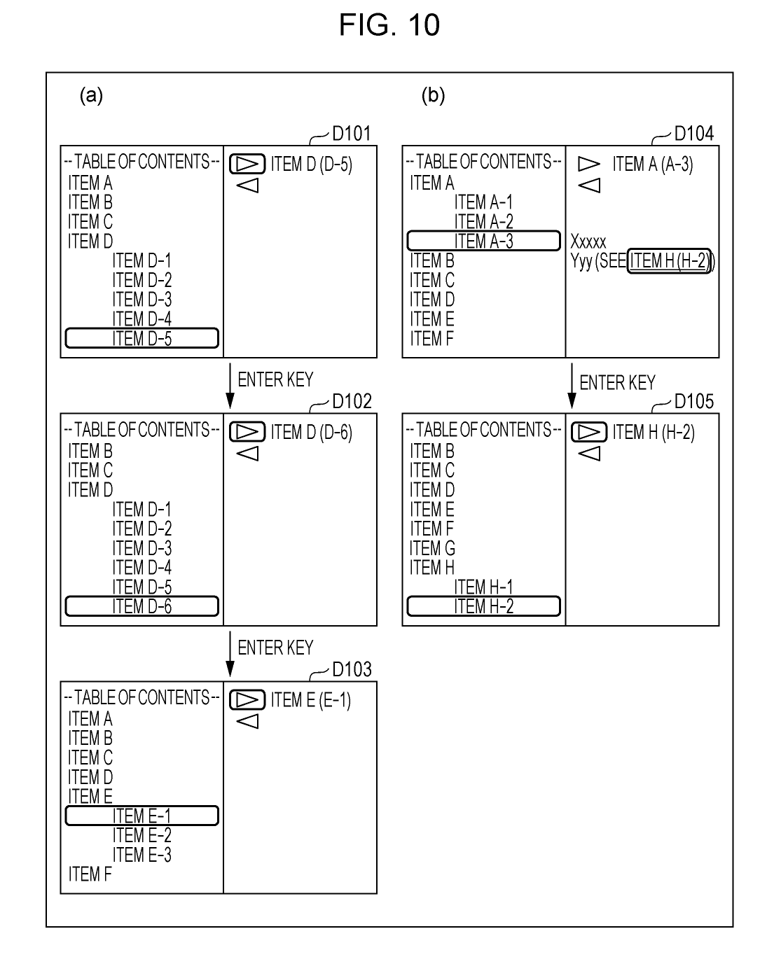

A display example of the electronic-document image D according to a third embodiment of the present invention will be described with reference to FIG. 10. The configurations of the television receiver 1 and the electronic-document image D according to the third embodiment of the present invention are the same as those in the first embodiment.

FIG. 10 is a diagram illustrating an example of automatic scrolling of the table-of-contents image C according to the third embodiment of the present invention. FIG. 10(a) illustrates an example of automatic scrolling of the table-of-contents image C that is performed in conjunction with paging of the text image T. As illustrated in FIG. 10(a), the table-of-contents image C is displayed in accordance with the following order of priority.

(1) Items are displayed in order from item A.

(2) In a case where a sub-item to be highlighted is not included in a display area, the table-of-contents image C is scrolled so that the sub-item is displayed at the bottom of the display area.

Hereinafter, the details will be described.

In an electronic-document image D101, the text of item D (D-5) is displayed as the text image T, and thus item D-5 is highlighted in the table-of-contents image C. Item D includes items D-1 to D-6. Item D-5 to be highlighted needs to be included in the display area of the table-of-contents image C. However, item D-5 is included in the display area even if the items are displayed in order from item A, and thus the items are displayed with item A at the top. In the text image T, the cursor is located on the page forward button B1.

Here, if the enter key is pressed, the text of item D (D-6) is displayed as the text image T and thus item D-6 is highlighted in the table-of-contents image C, as illustrated in an electronic-document image D102. Specifically, if the items are displayed with item A at the top, item D-6 is not included in the display area, and thus the table-of-contents image C is scrolled so that item D-6 is displayed at the bottom of the display area. As a result of scrolling, item A is hidden. In the text image T, the cursor is located on the page forward button B1.

Furthermore, if the enter key is pressed, the text of item E (E-1) is displayed as the text image T and thus item E-1 is highlighted in the table-of-contents image C, as illustrated in an electronic-document image D103. Specifically, the main item is changed from item D to item E, and thus item D is closed whereas item E is opened, and item E-1 is highlighted. Item E includes items E-1 to E-3. Even if the items are displayed with item A at the top, item E-1 is included in the display area, and thus scrolling is performed so that the items are displayed with item A at the top.

FIG. 10(b) illustrates an example of automatic scrolling of the table-of-contents image C that is performed in conjunction with movement to a link in the text image T. As illustrated in FIG. 10(b), in an electronic-document image D104, the text of item A (A-3) is displayed as the text image T, a link “item H (H-2)” is displayed in the text, and the cursor is located on the link. In the table-of-contents image C, item A-3 is highlighted.

Here, if the enter key is pressed, the text of linked item H (H-2) is displayed as the text image T and thus item H-2 is highlighted in the table-of-contents image C, as illustrated in an electronic-document image D105. Specifically, if the items are displayed with item A at the top, item H-2 is not included in the display area, and thus the table-of-contents image C is scrolled so that item H-2 is displayed at the bottom of the display area. As a result of scrolling, item A is hidden.

The third embodiment of the present invention relates to automatic scrolling of the table-of-contents image C and is applicable together with the first embodiment.

### Fourth Embodiment

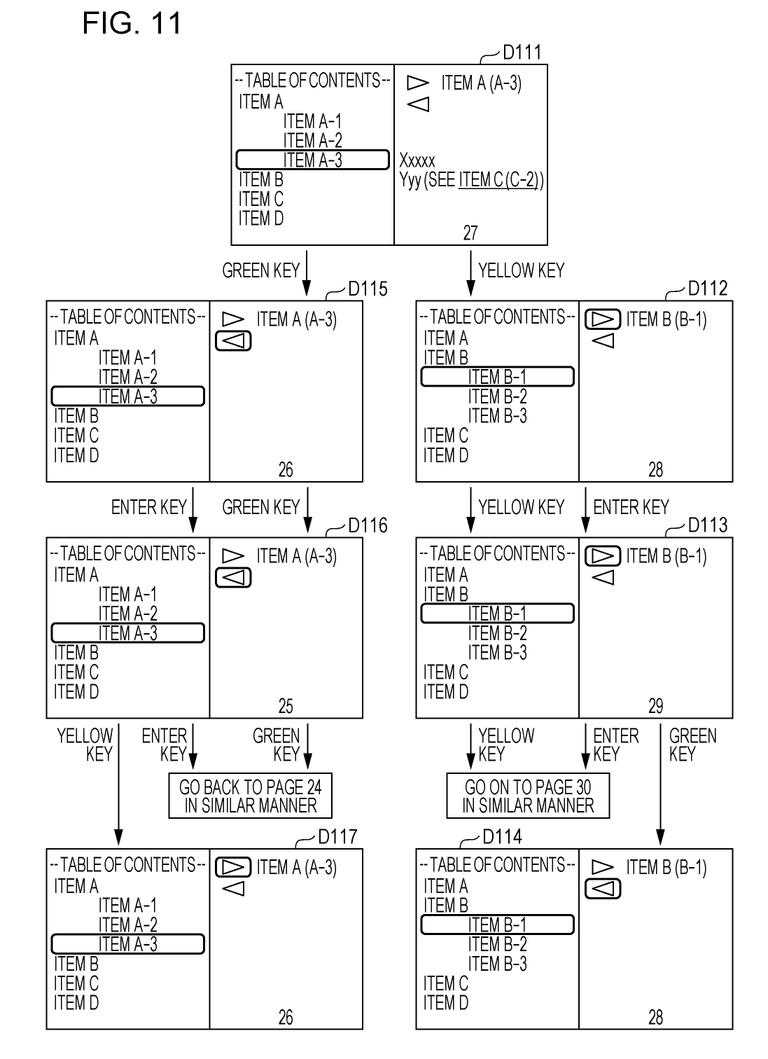

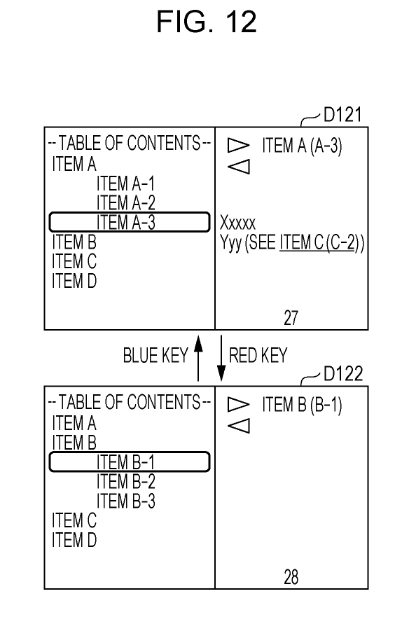

A display example of the electronic-document image D according to a fourth embodiment of the present invention will be described with reference to FIGS. 11 and 12. The configurations of the television receiver 1 and the electronic-document image D according to the fourth embodiment of the present invention are the same as those in the first embodiment.

FIG. 11 is a diagram illustrating a display example of a page forward operation and a page back operation using color keys in the text image T according to the fourth embodiment of the present invention. As illustrated in FIG. 11, a page forward operation and a page back operation can be performed by pressing the yellow key and the green key on the remote control. At the same time as the page forward operation and the page back operation, the cursor is located on the page forward button B1 and the page back button B2 in the text image T. Hereinafter, the details will be described.

In an electronic-document image DI 11 at the top, page 27 included in the text of item A (A-3) is displayed as the text image T, and in the table-of-contents image C, item A is opened and item A-3 is highlighted. The cursor is located on item A-3. Here, if the yellow key is pressed, page 28 included in the text of item B (B-1) is displayed as the text image T, and in the table-of-contents image C, item A is closed, item B is opened, and item B-1 is highlighted, as illustrated in an electronic-document image D112. At the same time as a page forward operation, the cursor moves to the text image T and is located on the page forward button B1.

If the yellow key or the enter key is pressed in the electronic-document image D112, the text of item B (B-1) advances by one page from page 28 and page 29 is displayed as the text image T, as illustrated in an electronic-document image D113. However, this is a page forward operation within item B-1 and thus the display of the table-of-contents image C is not changed. Also, the position of the cursor in the text image T is not changed. If the yellow key or the enter key is further pressed, a page forward operation is performed and the text advances by one page from page 29 to page 30 in a similar manner.

If the green key is pressed in the electronic-document image D113, the text of item B (B-1) goes back by one page from page 29 and page 28 is displayed as the text image T, as illustrated in an electronic-document image D114. However, this is a page back operation within item B-1 and thus the display of the table-of-contents image C is not changed. The cursor is located on the page back button B2 at the same time as the page back operation.

If the green key is pressed in the electronic-document image D111, the text of item A (A-3) goes back by one page from page 27 and page 26 is displayed as the text image T, as illustrated in an electronic-document image D115. However, this is a page back operation within item A-3 and thus the display of the table-of-contents image C is not changed. The cursor is located on the page back button B2 at the same time as the page back operation.

If the green key or the enter key is pressed in the electronic-document image D115, the text of item B (B-1) goes back by one page from page 26 and page 25 is displayed as the text image T, as illustrated in an electronic-document image D116. However, this is a page back operation within item B-1 and thus the display of the table-of-contents image C is not changed. Also, the position of the cursor in the text image T is not changed. If the green key or the enter key is further pressed, a page back operation is performed and the text goes back by one page from page 25 to page 24 in a similar manner.

If the yellow key is pressed in the electronic-document image D116, the text of item A (A-3) advances by one page from page 25 and page 26 is displayed as the text image T, as illustrated in an electronic-document image D117. However, this is a page forward operation within item A-3 and thus the display of the table-of-contents image C is not changed. The cursor is located on the page forward button B1 at the same time as the page forward operation.

According to the above, with use of the yellow key and the green key, it is not necessary to locate the cursor on the page forward button B1 and the page back button B2 in the text image T, and a page forward operation and a page back operation can be performed by one operation (one touch), which is very user friendly and convenient. Furthermore, if the yellow button and the green button are pressed, the cursor is located on the page forward button B and the page back button B2, which is user friendly in the case of moving the cursor in the text image T. In the case of performing a page forward operation or a page back operation without using a color key, it is necessary to press the enter key after locating the cursor on the page forward button B1 or the page back button B2.

FIG. 12 is a diagram illustrating a display example of a page forward operation and a page back operation using color keys in the table-of-contents image C according to the fourth embodiment of the present invention. As illustrated in FIG. 12, even in a case where the cursor is located in the table-of-contents image C, a page forward operation and a page back operation can be performed by pressing the red key and the blue key on the remote control. Hereinafter, the details will be described.

In an electronic-document image D121, the text of item A (A-3) is displayed as the text image T, and in the table-of-contents image C, item A is opened and item A-3 is highlighted. The cursor is located on item A-3. Here, if the red key is pressed, the text of item B (B-1) is displayed as the text image T, and in the table-of-contents image C, item A is closed whereas item B is opened and item B-1 is highlighted, as illustrated in an electronic-document image D122. The cursor is located on item B-1.

According to the above, the cursor is kept located in the table-of-contents image C, which is very user friendly and convenient in the case of turning pages forward or backward one by one temporarily during an operation of turning pages while relying mainly on the table of contents. In the case of performing a page forward operation or a page back operation without using a color key, it is necessary to press the enter key after locating the cursor on a sub-item.

The fourth embodiment of the present invention relates to paging with color keys, and is applicable together with the first embodiment.

### [Implementation Example Using Software]

The individual functional blocks of the television 1 illustrated in FIG. 1 (in particular, the electronic-document image generating unit 11, the command receiving unit 111, the table-of-contents image generating unit 112, the text image generating unit 113, and the image combining unit 114) may be implemented by a logic circuit (hardware) formed on an integrated circuit (IC chip) or the like, or may be implemented by software by using a central processing unit (CPU).

In the latter case, the television 1 includes a CPU that executes a command of a program which is software for implementing the individual functions, a read only memory (ROM) or storage device (these are referred to as a “recording medium”) on which the program and various pieces of data are recorded in a computer (or CPU) readable manner, and a random access memory (RAM) in which the program is expanded. With the program being read from the recording medium and executed by the computer (or CPU), an object of the present invention is achieved. As the recording medium, a “non-transitory tangible medium”, such as a tape, disc, card, semiconductor memory, or programmable logic circuit, may be used. The program may be supplied to the computer through a certain transmission medium (communication network, broadcast wave, or the like) capable of transmitting the program. The present invention may also be carried out in the form of a data signal embedded in a carrier wave, in which the program is embodied by electronic transmission.

### CONCLUSION

An image display device (television receiver 1) according to a first aspect of the present invention is an image display device that displays an image representing an electronic document on a display, including: a table-of-contents image generating unit (112) that generates a table-of-contents image (C) which represents a table of contents of the electronic document and which is to be displayed on the display, the table of contents having two or more layers; and a page image generating unit (text image generating unit 113) that generates a page image (text image T) which represents a page of the electronic document and which is to be displayed on the display, wherein the table-of-contents image generating unit changes an upper-level item that is opened in a generated table-of-contents image from a first upper-level item to a second upper-level item, in response to a change of an upper-level item including an item corresponding to the page image generated by the page image generating unit from the first upper-level item to the second upper-level item.

According to the above-described configuration, in a case where a page of the electronic document is switched, the upper-level item in the table of contents corresponding to the page is opened and displayed in conjunction with the switching. That is, in a case where a certain page is displayed, the item in the table of contents corresponding to the page becomes able to be referred to at the same time. Thus, the position of the page that is currently displayed (hereinafter referred to as a “displayed page”) in the electronic document can be easily determined.

In an image display device according to a second aspect of the present invention, in the first aspect, in the table-of-contents image generated by the table-of-contents image generating unit, the item corresponding to the page image generated by the page image generating unit may be depicted so as to be distinguishable from another item included in the upper-level item including the corresponding item.

According to the above-described configuration, an item in the table of contents corresponding to a displayed page is depicted so as to be distinguishable from another item. Thus, the item corresponding to the displayed page can be quickly recognized, and the position of the displayed page in the electronic document can be determined more easily.

In an image display device according to a third aspect of the present invention, in the first and second aspects, the table-of-contents image generating unit may close the first upper-level item that is opened in the generated table-of-contents image, in response to a change of the upper-level item including the item corresponding to the page image generated by the page image generating unit from the first upper-level item to the second upper-level item.

According to the above-described configuration, in a case where a page of the electronic document is switched, the upper-level item that does not include the item in the table of contents corresponding to the displayed page is displayed in a closed state in conjunction with the switching. That is, other items not included in the upper-level item in the table of contents corresponding to the displayed page are hidden. Therefore, since unnecessary items in the table of contents are not displayed, the table of contents that does not directly relate to the displayed page does not appear, the display size of the table-of-contents image can be reduced, and movement of a cursor in the table-of-contents image can be reduced.

An image display device according to a fourth aspect of the present invention may be, in the first to third aspects, an image display device that displays a part of the table-of-contents image, and, in a case where the item corresponding to the page image generated by the page image generating unit is out of a target to be displayed, scrolls the table-of-contents image so that the corresponding item is included in the target to be displayed.

According to the above-described configuration, even in a case where the item in the table of contents corresponding to the displayed page is not included in the display area of the table-of-contents image and it is impossible to refer to the item in the table of contents in such a display state, the item in the table of contents is included in the target to be displayed by scrolling the table-of-contents image, and accordingly the item in the table of contents can be referred to.

In an image display device according to a fifth aspect of the present invention, in the first to fourth aspects, in a case where a target to be operated is switched from the page image to the table-of-contents image, the table-of-contents image generating unit may switch a table-of-contents image to be generated to a table-of-contents image that is depicted to indicate that the item corresponding to the page image generated by the page image generating unit is the target to be operated.

According to the above-described configuration, in a case where a target to be operated is switched from a page image to a table-of-contents image, it is indicated that the item in the table of contents corresponding to the displayed page is the target to be operated. Thus, the item corresponding to the displayed page can be quickly determined and selected.

In an image display device according to a sixth aspect of the present invention, in the first to fifth aspects, the page image generated by the page image generating unit may include a page switch button for switching the page image, and in a case where a target to be operated is switched from the table-of-contents image to the page image, the page image generating unit may switch a page image to be generated to a page image that is depicted to indicate that the page switch button is the target to be operated.

According to the above-described configuration, in a case where a target to be operated is switched from a page image to a table-of-contents image, it is indicated that the page switch button is the target to be operated. Thus, an operation of switching a page can be preferentially and quickly performed.

In an image display device according to a seventh aspect of the present invention, in the first to sixth aspects, the page image generated by the page image generating unit may include a page switch button for switching the page image, and in a case where the page image is switched, the page image generating unit may switch a page image to be generated to a page image that is depicted to indicate that the page switch button is the target to be operated.

According to the above-described configuration, in a case where the page image is switched, it is indicated that the page switch button is the target to be operated, and thus an operation of switching a page can be consecutively performed.

In an image display device according to an eighth aspect of the present invention, in the first to seventh aspects, the page image generating unit may switch the page image in a case where a color key on a remote control (2) is pressed.

According to the above-described configuration, even if the target to be operated is a page image or a table-of-contents image, the page can be switched only by an operation of the color key of the remote control.

A television receiver according to a ninth aspect of the present invention includes the image display device according to the first to eighth aspects.

An image display method according to a tenth aspect of the present invention is an image display method for displaying an image representing an electronic document on a display, including: a table-of-contents image generation step of generating a table-of-contents image which represents a table of contents of the electronic document and which is to be displayed on the display, the table of contents having two or more layers; and a page image generation step of generating a page image which represents a page of the electronic document and which is to be displayed on the display, wherein the table-of-contents image generation step changes an upper-level item that is opened in a generated table-of-contents image from a first upper-level item to a second upper-level item, in response to a change of an upper-level item including an item corresponding to the page image generated in the page image generation step from the first upper-level item to the second upper-level item.

The present invention is not limited to the individual embodiments described above and can be variously changed within the scope indicated by the claims, and an embodiment obtained by appropriately combining technical means disclosed in different embodiments is included in the technical scope of the present invention. Furthermore, a new technical feature can be formed by combining technical means disclosed in the individual embodiments.

### INDUSTRIAL APPLICABILITY

The present invention can be used for an image display device that displays an image representing an electronic document on a display.

### REFERENCE SIGNS LIST

1 television receiver (image display device)
112 table-of-contents image generating unit
113 text image generating unit (page image generating unit)
2 remote control
C table-of-contents image
T text image (page image)

1. An image display device that displays an image representing an electronic document on a display, comprising:
a table-of-contents image generating unit that generates a table-of-contents image which represents a table of contents of the electronic document and which is to be displayed on the display, the table of contents having two or more layers; and
a page image generating unit that generates a page image which represents a page of the electronic document and which is to be displayed on the display,
wherein the table-of-contents image generating unit changes an upper-level item that is opened in a generated table-of-contents image from a first upper-level item to a second upper-level item, in response to a change of an upper-level item including an item corresponding to the page image generated by the page image generating unit from the first upper-level item to the second upper-level item.

2. The image display device according to claim 1, wherein, in the table-of-contents image generated by the table-of-contents image generating unit, the item corresponding to the page image generated by the page image generating unit is depicted so as to be distinguishable from another item included in the upper-level item including the corresponding item.

3. The image display device according to claim 1, wherein the table-of-contents image generating unit closes the first upper-level item that is opened in the generated table-of-contents image, in response to a change of the upper-level item including the item corresponding to the page image generated by the page image generating unit from the first upper-level item to the second upper-level item.

4. The image display device according to claim 1, wherein the image display device displays a part of the table-of-contents image, and, in a case where the item corresponding to the page image generated by the page image generating unit is out of a target to be displayed, scrolls the table-of-contents image so that the corresponding item is included in the target to be displayed.

5. The image display device according to claim 1, wherein, in a case where a target to be operated is switched from the page image to the table-of-contents image, the table-of-contents image generating unit switches a table-of-contents image to be generated to a table-of-contents image that is depicted to indicate that the item corresponding to the page image generated by the page image generating unit is the target to be operated.

6. The image display device according to claim 1, wherein
the page image generated by the page image generating unit includes a page switch button for switching the page image, and
in a case where a target to be operated is switched from the table-of-contents image to the page image, the page image generating unit switches a page image to be generated to a page image that is depicted to indicate that the page switch button is the target to be operated.

7. The image display device according to claim 1, wherein
the page image generated by the page image generating unit includes a page switch button for switching the page image, and
in a case where the page image is switched, the page image generating unit switches a page image to be generated to a page image that is depicted to indicate that the page switch button is the target to be operated.

8. The image display device according to claim 1, wherein the page image generating unit switches the page image in a case where a color key on a remote control is pressed.

9. A television receiver comprising the image display device according to claim 1.

10. An image display method for displaying an image representing an electronic document on a display, comprising:
a table-of-contents image generation step of generating a table-of-contents image which represents a table of contents of the electronic document and which is to be displayed on the display, the table of contents having two or more layers; and
a page image generation step of generating a page image which represents a page of the electronic document and which is to be displayed on the display,
wherein the table-of-contents image generation step changes an upper-level item that is opened in a generated table-of-contents image from a first upper-level item to a second upper-level item, in response to a change of an upper-level item including an item corresponding to the page image generated in the page image generation step from the first upper-level item to the second upper-level item.
